(19) United States
(12) Patent Application Publication
(10) Pub. No.: US 2007/0253356 A1
(43) Pub. Date: Nov. 1, 2007

(54) Wireless device and method of communicating data through a wireless device

(75) Inventors: Hai Dong Jiang, Beijing (CN); Shengqiang Wang, Raleigh, NC (US)

Correspondence Address: HARNESS, DICKEY & PIERCE, P.L.C., P.O. BOX 8910, RESTON, VA, 20195, US

(73) Assignee: Lucent Technologies Inc.

(21) Appl. No.: 11/604,252

(22) Filed: Nov. 27, 2006

(30) Foreign Application Priority Data
Apr. 28, 2006 (CN) 200610151397.X

(51) Int. Cl. H04Q 7/00

(52) U.S. Cl. 370/328; 370/331

(57) ABSTRACT

A wireless device including a controller controlling operations of the wireless device based on the operating mode of the wireless device for data services. The operating mode is one of a normal mode and a serving mode. The normal mode being where the wireless device acts as a normal endpoint of a data communication system and the serving mode being where the wireless device serves as a service access point for the data communication system.

### PRIORITY STATEMENT

This non-provisional U.S. patent application claims priority under 35 U.S.C. § 119 to Chinese Patent Application No. 200610151397.X, filed on Apr. 28, 2006, the entire contents of which are incorporated herein by reference.

### BACKGROUND OF INVENTION

The present invention relates generally to a communication system and method, and more specifically to a communication system including a wireless device configured to serve as a Service Access Point (SAP) for data services for one or more local Internet Protocol (IP) devices such as an IP TV or a personal computer.

Currently, a large portion of the population subscribes to one or more of an Internet service, a landline telephone service, a wireless telephone service, and a television service. Because each of these services are often provided by different service providers, the costs and inconvenience of obtaining a combination of these different services from different service providers may cause a significant burden on a user.

The costs associated with obtaining the different services further increase because the services may require different wired connections to be implemented at a user's residence. For example, a user's residence may have to be separately wired for a landline telephone, Internet service and/or television service.

Further, as a user adds options to each of the services described above, the cost associated with the service further increases. For example, many users pay additional money to obtain a relatively higher access speed for the Internet.

At least in part due to the above costs and inconveniences of dealing with different service providers, a growing number of mobile telephone users are abandoning traditional landline telephones as their main home telephones in favor of using their mobile telephones as their main home telephones. Using a mobile telephone as a home telephone provides the advantages of having only one telephone number for travel and at home and allows users to contract with only a single service provider.

However, users still generally subscribe with different service providers for Internet services, wireless telephone services and television services. Further, users generally still receive these services through different wired and/or wireless connections.

### SUMMARY OF THE INVENTION

One or more example embodiments of the present invention are directed towards a communication system including a wireless device configured to serve as a Service Access Point (SAP) for one or more local devices such as an IP TV or a personal computer.

An example embodiment of the present invention provides a method of communicating data through a wireless device. The method includes determining an operating mode of the wireless device for data service, receiving information and processing the received information based on the determined operating mode. The operating mode of the wireless device is one of a normal mode and a serving mode. For data service, the normal mode being where the wireless device functions as an endpoint and the serving mode being where the wireless device functions as a service access point. For voice service, the wireless device always operates in its normal way.

According to an example embodiment of the present invention, the method may also include detecting a trigger and switching the operating mode of the wireless device in response to the detected trigger. Further, the detecting step detects at least one of user input, a local device and a connection to a docking station as the trigger.

An example embodiment of the present invention provides a wireless device. The wireless device includes a controller controlling operations of the wireless device based on the operating mode of the wireless device. The operating mode is one of a normal mode and a serving mode. The normal mode being where the wireless device acts as an endpoint of a data communication and the serving mode being where the wireless device serves as a serving access point (SAP) for the data communication.

According to an example embodiment of the present invention, the wireless device may also include a transceiver. The transceiver transfers information to and from at least one local IP device if the wireless device is operating in the serving mode for data communication. The at least one local device is one or more of an IP router, an IP TV, a personal computer, an IP phone and a PC phone.

According to an example embodiment of the present invention, the wireless device may also include a processor processing information based on instructions received from the controller if the wireless device is operating in the normal mode.

According to an example embodiment of the present invention, the wireless device may also include a detector detecting a trigger. The controller switches the operating mode of the wireless device for data service in response to a trigger detected by the detector.

### BRIEF DESCRIPTION OF THE DRAWINGS

Example embodiments of the present invention will become more fully understood from the detailed description given herein below and the accompanying drawings, wherein like elements are represented by like reference numerals, which are given by way of illustration only and thus are not limiting of the present invention and wherein:

FIG. 1 is a system including a wireless device configured to serve as a SAP for data services for one or more local IP devices according to an example embodiment of the present invention;

FIG. 2 is a block diagram of a wireless device according to an example embodiment of the present invention; and

FIG. 3 is a flow chart illustrating a method for communicating according to an example embodiment of the present invention.

### DETAILED DESCRIPTION OF EXAMPLE EMBODIMENTS

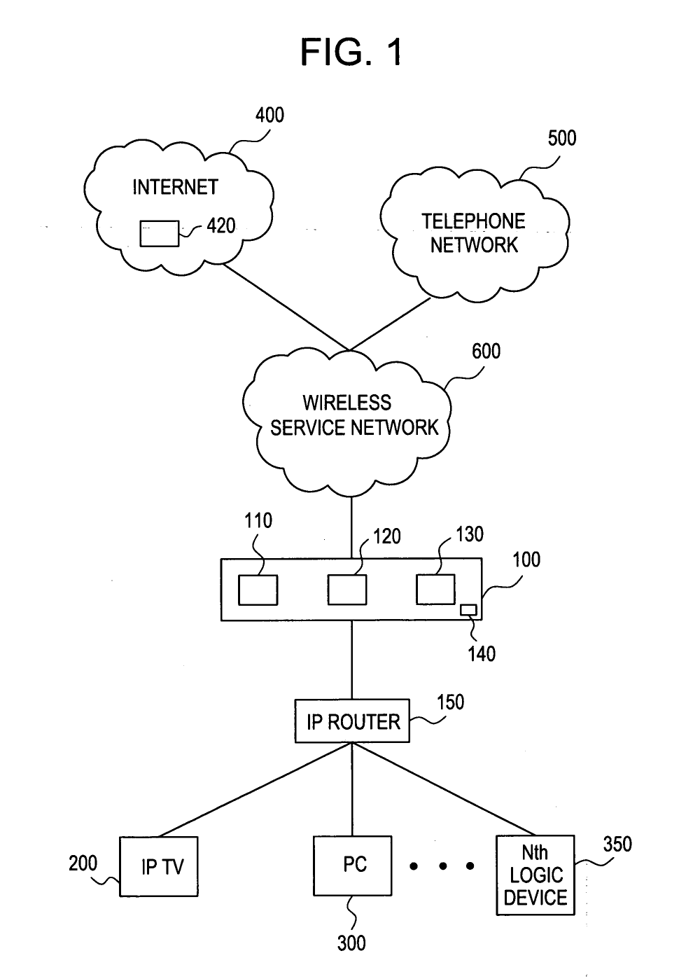

FIG. 1 is an example system including a wireless device configured to serve as a Service Access Point (SAP) for one or more local IP devices according to an example embodiment of the present invention.

Before describing a wireless device according to an example embodiment of the present invention, the system components using the wireless device to communicate with each other will be described.

In FIG. 1, a wireless device 100 is used to communicate data between a wireless service network 600 and one or more local devices described below. Information communicated between the wireless service network 600 and the wireless device 100 is transferred over an air interface and the information communicated between the wireless device 100 and the local IP devices is transferred using the Internet Protocol (IP).

The wireless service network 600 according to an example embodiment of the present invention provides access to both the Internet 400 and a PSTN telephone network 500. The structure and function of the Internet 400 and the PSTN telephone network 500 are well-known in the art and will not be discussed herein for the sake of brevity.

The local IP devices according to an example embodiment of the present invention include, but are not limited to, an IP TV, a personal computer, a PC phone, an IP phone, etc. In FIG. 1, the local devices are shown as an IP TV 200, a personal computer 300 and a generic N^{th} local device to illustrate that the wireless device 100 is configured to serve as an SAP for N local devices. The N^{th} local device 350 may be a second IP TV, a second personal computer, a PC phone, or an IP phone, for example. The structure and function of an IP TV, a personal computer, a PC phone, and an IP phone are also well-known in the art and will not be discussed herein for the sake of brevity.

An IP router 150 is connected between the wireless device 100 and the local devices according to an example embodiment of the present invention. IP routers are well known in the art and will not be described herein for the sake of brevity. It is noted that the IP router 150 may be omitted when the wireless device 100 is only connected to a single local IP device.

A wireless device 100 according to an example embodiment of the present invention can be triggered to serve as a SAP for data service for one or more IP local devices.

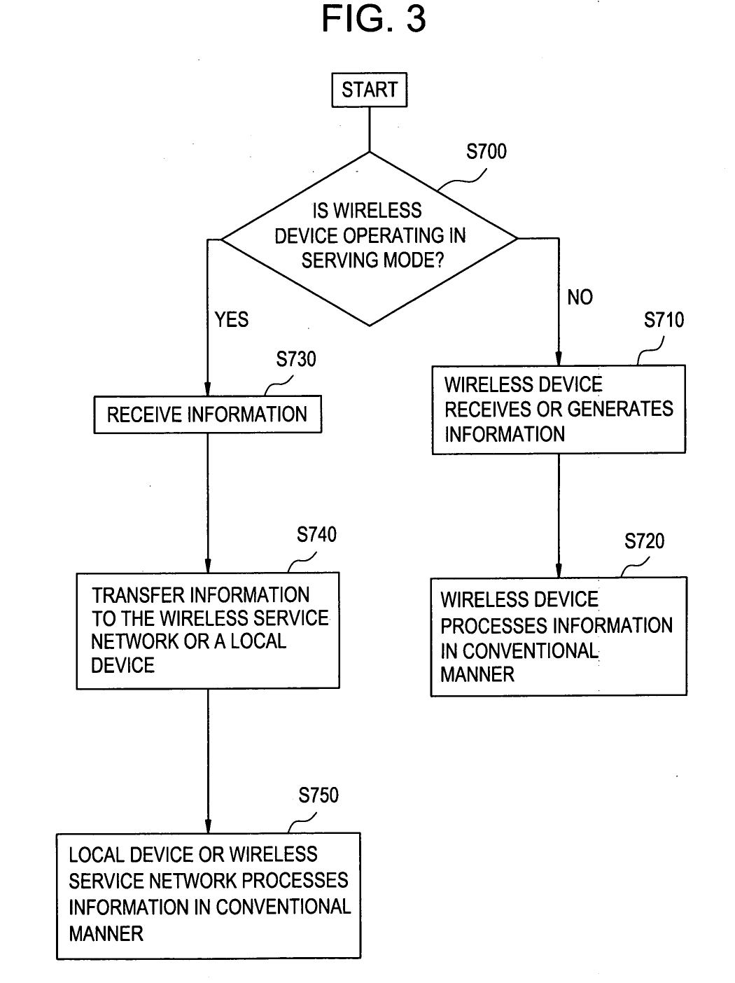

The wireless device 100 may be a wireless telephone, personal digital assistant (PDA), etc. The wireless device 100 operates in a normal mode or operating mode. The normal mode being where the wireless device 100 functions as an endpoint of a communication system, and the serving mode being where the wireless device 100 functions as a SAP for data services. It is noted that if the wireless device 100 is a wireless telephone, the telephone functions in a conventional manner for traditional voice services regardless of whether the telephone is operating in a serving mode or normal operating mode as described later with respect to the flow chart of FIG. 3.

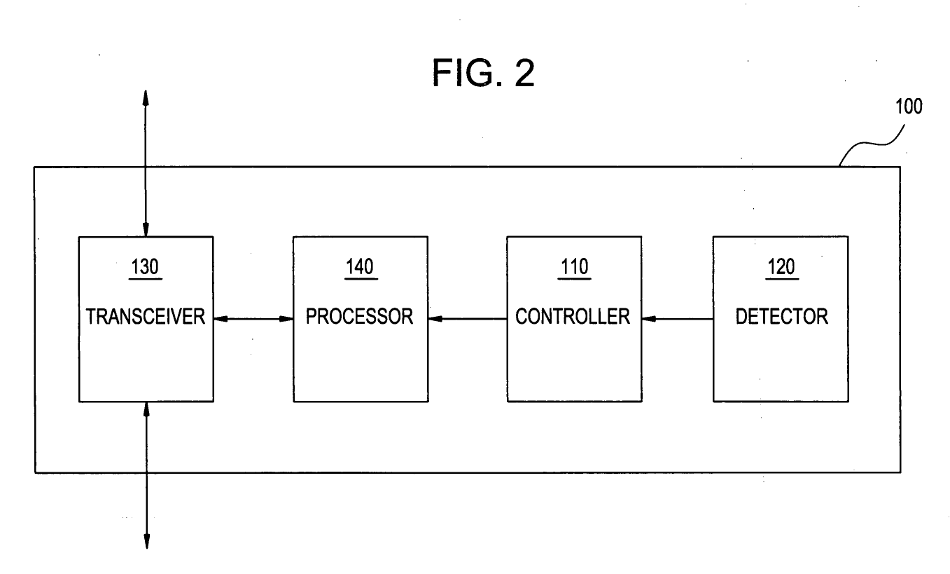

The wireless device 100 according to an example embodiment of the present invention can be triggered to serve as a SAP for local IP devices for data services. As shown in FIG. 1, and in more detail in FIG. 2, the wireless device 100 includes a transceiver 130, a processor 140, a controller 110 and a detector 120. The transceiver 130 receives data from and transmits data to the wireless service network 600 and/or the local IP devices. The processor 140 processes the received data based on instructions received from the controller 110. The detector 120 detects a trigger causing the wireless device 100 to switch from a normal operating mode to a serving mode for data services. In the serving mode, the wireless device 100 serves as a SAP for the one or more local IP devices. The controller 110 controls the operations of the wireless device 100 during both the normal operating mode and the serving mode for data service by providing instructions to the processor 140.

The detector 120 may be configured to detect a variety of different triggers. A trigger may be a user input or the detection of one or more local IP devices. For example, the user may press a button to switch the operating mode of the wireless device 100.

Further, the detector 120 of the wireless device 100 may automatically detect the presence of one or more local IP devices, which use the wireless device 100 as a SAP for data services. For example, the wireless device 100 may serve as a SAP for one or more of the local IP devices included in a user's home and thus, when the user is at home and connects the wireless device 100 to the IP router 150 or any other IP device, the detector 120 of the wireless device detects the presence of the connected local IP devices in the home.

The physical connection between the wireless device 100 and an IP device (either the IP router 150 or any other IP device) may be a direct connection to the wireless device or a connection through a docking station (not shown), which is typically used for electrical charging, but may be used for other purposes. Connecting the wireless device 100 to the docking station may be a trigger causing the wireless device 100 to operate in a serving mode for data services if any IP device is connected to the docking station.

When the wireless device 100 is operating in the serving mode for data services, the controller 110 causes the wireless device 100 to act like an IP proxy server. Accordingly, the wireless device 100 only transfers data back and forth between the wireless service network 600 and the local devices.

As shown in FIG. 1 when the wireless device 100 is operating in the serving mode for data services, the controller 110 of the wireless device 100 causes the wireless device 100 to transfer data back and forth between the wireless service network 600 to the IP router 150.

FIG. 3 is a flow chart illustrating a method for communicating information between the wireless service network 600 and the wireless device 100 or the one or more local IP devices using the wireless device 100 as a SAP if the wireless device 100 is operating in a service mode for data services. For traditional voice services (non-VoIP services), the wireless device 100 operates in its conventional manner.

In step S700, the controller determines if the wireless device 100 is operating in a serving mode for data services. For example, when a wireless device 100 is powered on, the default mode of the wireless device 100 may be the normal operating mode. Accordingly, the controller 110 causes the wireless device 100 to operate in a normal operation mode until the detector 120 detects a trigger for switching the wireless device 100 from the normal operating mode to the serving mode for data services. If the detector 120 detects a trigger for switching the wireless device 100 from the normal operating mode to the serving mode for data services, the controller 110 causes the wireless device 100 to operate in the serving mode for data services.

If the wireless device 100 is in a normal operating mode, the wireless device acts as a normal IP end point and receives or generates information as shown in step S710 of FIG. 3. For example, if the wireless device 100 is a wireless telephone, the transceiver 130 of the wireless telephone may receive IP data packages from the wireless service network 600.

In step S720, the wireless device processes the information in a conventional manner. For example, the wireless device 100 receives an Instant Message forwarded by the wireless service network 600. The transceiver 130 sends the received information to the processor 140, and the processor 140 processes the information based on the instructions of the corresponding software installed in the wireless device 100.

Alternatively, if the wireless device 100 is in a serving mode for data services, the wireless device 100 receives information in step S730. The received information is data corresponding to one or more of the data services provided by the wireless service network 600 when the wireless device 100 is operating in the serving mode.

For example, the wireless service network 600 may provide television service to the IP TV 200 through the wireless device 100. Accordingly, the received information may be television programming data transmitted from the wireless service network 600 to the IP TV 200. Further, the television service may provide Video on Demand (VOD) services and/or Digital Video Recording (DVR) services. Accordingly, the IP TV 200 transmits requests for data related to these services to the wireless device 100, and the wireless device 100 transmits the requests to the wireless service network 600.

The wireless service network 600 may also provide Internet service to the personal computer 300 through the wireless device 100 operating in the serving mode. Accordingly, the received information transferred by the transceiver 130 of the wireless device 100 operating in the serving mode may be data downloaded from the Internet in response to a search initiated by the personal computer 300, for example. Received information transferred by the transceiver 130 of the wireless device 100 between the wireless service network 600 and the personal computer 300 may also be emails, Instant Messages, etc.

The wireless service network 600 may also provide VoIP (Voice over IP) telephone service to local devices, for example an IP phone. Accordingly, the received information transferred by the transceiver 130 of the wireless device 100 operating in the serving mode may be VoIP data.

In step S740, the wireless device 100 transfers the received information to the wireless service network 600 when the information is received from the local IP devices or to the local devices when the information is received from the wireless service network 600. For example, if the transceiver 130 receives an Instant Message from the wireless service network 600, the received Instant Message is transferred to the IP router 150. The IP router 150 then routes the Instant Message to the personal computer 300.

In step S750, the local device or the wireless service network 600 processes the transferred information in a conventional manner. For example, the personal computer 300 may receive the Instant Message, display the Instant Message, save the Instant Message, etc.

Example embodiments of the present invention, as described above, provide a communication system and method providing data service access through a single wireless device operating in a serving mode for data services. Accordingly, the communication system and method, as described above, simplify a home communication network for receiving Internet service, VoIP telephone service and IP television service. Further, because the costs and inconveniences of dealing with a single service provider is generally less than the costs and inconveniences when dealing with different service providers for each service, consumers may be able to obtain the desired services at a lower cost.

An example embodiment of the present invention being thus described, will be obvious that the same may be varied in many ways. Such variations are not to be regarded as a departure from the invention, and all such modifications are intended to be included within the scope of the invention.

What is claimed:

1. A method of communicating data through a wireless device, the method comprising:
determining an operating mode of the wireless device for data service, the operating mode being one of a normal mode and a serving mode, the normal being where the wireless device functions as an endpoint and the serving mode being where the wireless device functions as a serving access point;
receiving information; and
processing the received information based on the determined operating mode.

2. The method of claim 1, further comprising:
detecting a trigger; and
switching the operating mode to another of the normal mode and the serving mode based on the detected trigger.

3. The method of claim 2, wherein the determining step determines the operating mode is a default mode until the detecting step detects the trigger, and the default mode is one of the normal mode and the serving mode.

4. The method of claim 2, wherein the detecting step detects at least one of user input, a local device and a connection to a docking station as the trigger.

5. The method of claim 1, wherein the processing step comprises:
transferring the received information to a local IP device if the determining step determines that the wireless device is operating in the serving mode and the received information is received from a wireless service network.

6. The method of claim 1, wherein the processing step comprises:
transferring the received information to a wireless service network if the determining step determines that the wireless device is operating in the serving mode and the received information is received from a local IP device.

7. The method of claim 5, wherein the received information is at least one of television programming data, VoIP data, an Instant Message, an email and Internet download data.

8. The method of claim 6, wherein the received information is at least one of a request for television programming data, VoIP data, an Instant Message, an email, and Internet upload data.

9. A wireless device comprising:
a controller controlling operations of the wireless device based on an operating mode, the operating mode being one of a normal mode and a serving mode, the normal mode being where the wireless device acts as an endpoint of a communication system and the serving mode being where the wireless device serves as a serving access point (SAP) for the communication system.

10. The wireless device of claim 9, further comprising:
a transceiver transferring information to and from at least one local IP device if the wireless device is operating in the serving mode.

11. The wireless device of claim 10, wherein the at least one local IP device is one or more of an IP router, an IP TV, a personal computer, an IP phone, and a PC phone.

12. The wireless device of claim 10, wherein the transferred information includes at least one of television programming data, a request for television programming data, VoIP data, an Instant Message, an email, Internet download data and Internet upload data.

13. The wireless device of claim 9, further comprising:
a transceiver transferring first information to and from at least one local IP device if the wireless device is operating in the serving mode; and
a processor processing second information based on instructions received from the controller if the wireless device is operating in the normal mode.

14. The wireless device of claim 9, further comprising:
a detector detecting a trigger; and
the controller switching the operating mode between the normal mode and the serving mode in response to the detected trigger.

15. The wireless device of claim 14, wherein the detector detects at least one of user input, a local device and a connection to a docking station as the trigger.

16. The method of claim 9, wherein the wireless device is a wireless telephone.

17. The method of claim 9, wherein the wireless device is a personal digital assistant.
